(19) United States
(12) Patent Application Publication
(10) Pub. No.: US 2002/0053139 A1
(43) Pub. Date: May 9, 2002

(54) ROTARY CUTTING DEVICE

(76) Inventor: TERRENCE JAMES PARKE, MELTON (AU)

Correspondence Address: Kevin C. Brown, BURR & BROWN, P.O. BOX 7068, SYRACUSE, NY, 13261-7068, US

(21) Appl. No.: 09/381,842

(22) PCT Filed: Mar. 27, 1998
(86) PCT No.: PCT/AU98/00216

(30) Foreign Application Priority Data
Mar. 27, 1997 (AU) P05923

(51) Int. Cl. B26B 19/14

(52) U.S. Cl. 30/205; 30/240; 30/329

(57) ABSTRACT

A replaceable cartridge (20) is provided suitable for use with a rotary handpiece that is particularly adapted for shearing sheep. The cartridge (20) is provided with a plurality of radially directed projections (24) with which are associated a plurality of aligned recesses (26) for releasably receiving cutting elements in the form of elongate chips (22) preferably having a V-shape with a centrally located longitudinal groove. The replaceable cartridge allows for the quick and easy replacement of blunt or damaged cutting chips by either allowing individual chips to be replaced within the cartridge or by replacing the cartridge with a fresh cartridge having new chips.

The present invention relates to a rotary cutting device in general, and to a rotary handpiece for cutting materials in particular. More particularly, the present invention relates to a cutting device used as or in conjunction with shearing equipment for shearing hair, fur, wool or the like from animals or humans. The cutting device may be hand held or may be used in other equipment such as robotic machinery, particularly robotic machinery for shearing sheep or preparing cattle for slaughter. Additionally, the present invention finds application in cutting other natural or synthetic materials such as metals, paper and fibres such as for example textiles and the like. Even more particularly, the present invention relates to a hand held rotary shearing or cutting device which can be used by shearers for shearing wool from sheep or for preparing cut lines in cattle about to be slaughtered in abattoirs. One important aspect of the present invention is the provision within the handpiece of a rotary cutting means and a replaceable cartridge contacting a plurality of replaceable cutting elements or chips in which the rotary cutting means and cutting elements cooperate with each other to cut or sever material such as wool located therebetween.

Although the present invention will be described with particular reference to a rotary handpiece for shearing sheep, in which the rotary handpiece has a replaceable cartridge containing a plurality of cutting elements or chips, it is to be noted that the scope of the present invention is not limited to the described arrangement or embodiment of the replaceable cartridge but rather the scope is more extensive so as to include other arrangements of the replaceable cartridge and uses of the cartridge in applications other than the rotary handpiece and to other forms and uses of the rotary handpiece.

Currently, shearers almost universally use handpieces of the reciprocating or oscillating type, that is, handpieces having a fixed comb and a moveable cutter held in intimate contact with each other by a strong compressive force between the two. As the cutter reciprocates or oscillates in intimate contact with the fixed comb, heat is produced by the friction between the two components due to the compressive force. Such handpieces are generally heavy and cumbersome and require a large amount of energy or power to drive and require a great deal of effort and energy to be expended by the operator during their use. In addition, owning to the vibration and heat generated by the reciprocating movement of such conventional handpieces, their use for lengthy periods is very fatiguing for the shearers and results in more or less permanent injury to the shearers, such as for example, repetitive strain injuries or the like. In addition, conventional handpieces require lubrication which to some extent is provided by the natural lubricants present in the wool, such as lanolin, but in other cases, additional lubrication is required if the handpiece is to continue operating without getting too hot to be safely handled. The additional lubrication required adds to the time and effort needed to maintain the handpiece in good working order and sometimes may adversely affect the fleece by staining it or the like.

A further disadvantage of conventional reciprocating or oscillating handpieces is that they are inherently unsafe to use and require a great deal of expertise and training before they can be used in an effective manner which is safe for both the shearer and the sheep. It sometimes takes years of practice before a shearer becomes proficient enough to use the handpieces with confidence and to be regarded as having sufficient expertise with such handpieces.

Other disadvantages of conventional include the problems of the cutter producing vibrations within the handpiece as it oscillates; heat build up due to frictional forces; the cutters and combs requiring regular replacement or sharpening; the need to provide sufficient lubrication; injury to and burning of the sheep and on occasions, the shearer; and, should the handpiece be dropped or knocked from the shearer's hand it can often continue operating in an out-of-control manner which is extremely dangerous for persons or animals in close proximity to the handpiece as well as damaging to the handpiece. In these cases the handpiece must be disconnected from its driving means before it can be approached and ultimately retrieved.

A further disadvantage of conventional oscillating shearing handpieces is that the cutting blades must be sharpened frequently, particularly during periods of extended use. It is not uncommon for the comb and cutters of conventional handpieces to require sharpening only after being used for an hour or so. Due to the construction of such conventional handpieces the comb and cutters must be removed from the handpiece, sharpened and then replaced into the handpiece. The dual problem of continual use and repeated sharpening results in the cutters and comb wearing very quickly, often to a point where they are no longer serviceable or useable and accordingly must be discarded. Since the combs and cutters are expensive to produce and maintain, their premature replacement is costly.

Efforts have been made in recent times to provide a handpiece which has vibration characteristics which are less likely to cause injury, which is safer to use than conventional handpieces; which can operate at a lower temperature; which requires no or less lubrication; and which is less likely to cause injury to shearers, shed personnel and to the sheep. Australian provisional patent application No. PN0883 describes a rotary handpiece which contributes significantly to overcoming the problems associated with the oscillating handpieces of the prior art. The rotary handpiece of Australian provisional patent application No. PN0883 also provides a rotary handpiece which has blades and other cutters which have a longer useful working life than those known previously, are relatively cheaper to manufacture and maintain and which are of such low cost that they may be discarded when blunt and no longer serviceable and replaced by new blades or other cutters so that resharpening of the blades is not required. Such rotary handpieces can be mastered quickly even by novices.

It has now been found that a modified or improved rotary handpiece can be provided which has fewer parts and which provides greater ease of replacement of cutters compared with the rotary handpieces of the prior art. The new rotary handpiece also provides cutter replacements which are inexpensive to manufacture and replace compared with the cutters or blades of the prior art.

According to the present invention there is provided a rotary handpiece suitable for cutting or severing a material comprising,

a cutting member capable of rotary motion in a first direction, and at least one cutting element capable of substantially linear movement in a second direction, said motion in the first direction being different to movement in the second direction, and

a replaceable cartridge provided with a plurality of recesses, wherein the replaceable cartridge comprises a plurality of cutting elements removably located in respective recesses in the cartridge, and

wherein said cutting member is arranged with respect to the cutting elements such that the cutting member and cutting elements cooperatively interact with each other in use to cut material located therebetween.

According to a further aspect of the present invention there is provided a replaceable cartridge suitable for use in a rotary handpiece having a rotary cutting member, said replaceable cartridge comprising a body portion having a plurality of recesses, said recesses being adapted for releasably receiving respective cutting elements, wherein in use the replaceable cartridge is located in the handpiece in such a manner that the rotary cutting member and the cutting elements cooperatively interact with each other in use to cut material located therebetween.

According to another aspect of the present invention there is provided a comb in combination with a replaceable cartridge for use in a rotary handpiece, said cartridge comprising a body portion having a plurality of recesses extending radially outwardly from the body portion, said recesses being adapted to receive replaceable cutting elements, said body further comprising outwardly and radially extending projections associated with the recesses, said projections being provided with retaining means for retaining the cutting elements in the recesses, wherein said cutting elements are free to move axially within the recesses in operation of the handpiece.

Typically, the rotary handpiece comprises a handle portion, a hub, a body portion and a guide means. The guide means typically comprises a plurality of narrow, elongate fingers which form a comb or similar for guiding the rotary handpiece along a predetermined pathway through the material to be severed, such as for example through the covering of an animal, being wool, fur, hair or the like. Typically, the guide means is integral with the body portion of the handpiece. Typically, the cutting member and the cartridge are each separately removably mounted or connected to the body of the rotary handpiece. Typically, the cartridge is substantially stationary when located in the handpiece.

Typically, the cutting member is substantially planar, such as, for example, a rotatable disc having a plurality of generally radially directed cutting surfaces in the form of teeth. More typically, each tooth is generally arcuate having at least one of the leading edge or trailing edge of the tooth being curved, preferably both edges are arcuate. More typically, each tooth has a leading edge and a trailing edge shaped so that the teeth are swept back with respect to the normal direction of rotation of the blade in use. Even more typically, the teeth are radially arcuately curved. Even more typically, both the leading and trailing edges of the teeth are curved in the same direction. Typically, the cutting member is resiliently mounted or connected to the handpiece by a mounting means or connection means in such a manner so as to permit rotary movement of the cutting member with respect to the body of the rotary headpiece and the mounting means or connection means. Typically, the movement of the cutting member is in the direction of the plane of the cutting member.

Typically, the cartridge of the present invention comprises a generally curved or crescent shaped body portion comprising a plurality of protections extending substantially radially outwards from the curved body portion. Typically, the projections are regularly spaced apart. More typically, the projections have individual shapes. Even more typically, the projections, while being generally radially directed, are arranged to extend individually radially from the body of the cartridge. Even more typically, the angle of extension of the individual radially extending projections gradually changes depending on the exact location of the projection on the cartridge. Even more typically, the recesses in which the cutting elements are releasably located are positioned adjacent each projection.

Typically, the recesses are located such that when a cutting element is located in the recess, the cutting element extends in the direction of the projection, that is, radially outwards from a potion of the curved body portion. More typically, a cutting edge or surface of the cutting element is exposed when the cutting element is in the recess. Preferably the portion that is exposed is located at or towards is the aide of the body located between adjacent projections. Typically, the cutting elements are removably held within the recesses by interference fit, a keyway, a positive retention means or the like.

Typically, should a cutting element become broken or damaged, the cutting element can be levered out of the recess in which it is located or otherwise removed from the recess using a fingernail or similar tool and discarded or replaced with a new cutting element. If several cutting elements are blunted or broken in use, the entire cartridge may be removed from the handpiece and discarded and a new cartridge inserted in the handpiece.

Typically, in use, each of the projections of the body portion of the cartridge can be lined up with a finger in the guiding means. More typically, each finger of the guiding means comprises a flange, lip, recess or the like for retaining or guiding the corresponding projection of the cartridge into place. Typically, the body portion of the cartridge comprises a plastic or polymer based composition such as a nylon based polymer or the composition available polyethyleterphthalate based polymer known as ERTALYTE. (ERTALYTE is a trade mark.) The plastic to metal contact between the cartridge and the cutting elements results in low heat being produced due to the low friction of the surfaces and the self-lubrication properties of the plastics which contribute to the ability of the rotary handpiece to be operated continuously, and typically without the need for additional lubrication. Typically, the body portion and the cutting elements are manufactured at a low cost such that it is economical to discard an old cartridge once the cutting chips have become too worn to continue being used or individual chips hate been damaged or lost.

Typically, the cartridge comprises a biasing means. In use the biasing means provides bias between the cartridge and the body of the rotary handpiece. Typically, the biasing means comprises a piece of resilient material, such as for example rubber or plastics or polymers, particularly plastic or polymeric tubing. Typically, the biasing means is a length of a tube, pipe or similar of plastics or rubber material. The tube or pipe may be solid or hollow. Typically, the biasing means is held by interference fit in an elongate depression in the body of the cartridge. It will be readily appreciated by those skilled in the art that different biasing forces can be achieved by using materials of different resiliencies. Typically, the biasing means comprises a piece of polymer tubing such as surgical tubing located in a shallow, curved depression in the body portion of the second cutting member. Other biasing methods and means are contemplated by the present invention.

Typically, the cutting chip is maintained in position in its recess by a flange, lip or groove provided in the distal end of the projection. More typically, the flange, lip or groove is of sufficient size to allow the chip to move linearly in its lengthwise extending direction in use whilst being retained in the recess at all times, i.e. the movement of the chip in use is insufficient for the chip to be displaced from the recess in normal use.

Typically, the cartridge of the present invention is mounted or connected to the headpiece by mechanical means. More typically, the cartridge is mounted on the handpiece by a hooking means such as a flange located either on the body of the cartridge or on the rotary handpiece. Typically, the rotary handpiece comprises the flange and the cartridge comprises a complimentary recess in which the flange may be received. Where the cartridge is held in place on the rotary handpiece by a flange, the biasing means may act to urge the cartridge against the flange thereby providing positive location of the cartridge within the handpiece. The rotary handpiece may comprise additional guide means or stops for ensuring that the cartridge is located in the correct position relative to the handpiece and relative to the cutting surfaces of the cutting member. Stop means, if provided, prevent rotation of the cartridge in the plane corresponding to the plane of rotation of the blade. In one embodiment, the flange, lip or groove for locating the chip is on one side of the projection, preferably the underside in use, while the other side of the projection is adapted or shaped to fit into a corresponding flange, lip or groove provided on the body of the handpiece or on a component of the handpiece.

Typically, the cutting element of the present invention is a generally triangular prism shaped blade or chip. More typically, the chip is V-shaped in cross-section, preferably a hollow V-shape chip, and is provided with a centrally located lengthwise extending groove over the entire length of the chip. More typically, the cutting element is arranged so that in the normal in use position of the cutting device the base of the triangular blade or chip is oriented towards the cutting surfaces of the rotary blade. More typically, the chip is provided with a cutting surface which is in contact with the cutting surface of the rotary blade, preferably the teeth of a rotary blade.

Typically, where the cutting element is a triangular prism like shaped chip, the chip is provided with a number of surfaces which are parallel to each other. More typically, all but one of the surfaces are parallel. Most typically, the surface which is not parallel to the other surfaces is a tapering surface or an oblique surface arranged to extend at an acute angle to the parallel surfaces.

Typically, the end of the cutting chip bearing against the resilient biasing means is provided with an extension piece, tab, bearing, pad or similar so that the biasing means is not damaged by being punctured or cut in use.

Typically, where the cartridge comprises a biasing means the biasing means acts to bias or retain the cutting elements in the recesses of the body portion of the cartridge. More typically, where the cutting elements comprise triangular prism like shaped chips, one apex of the chips is in contact with the biasing means and the biasing means acts to retain the prism in the recess in the body portion.

The cutting elements such as chips may be made from any suitable material or combination of materials. For example the cutting elements may comprise metal or synthetic material such as plastics or polymers, or may comprise a mixture of components such as polymer coated metal. The cutting elements may for example, be manufactured by cutting metal rod, bent sheet metal, metal pipe or the like.

The handpiece of the present invention typically comprises an adjustment means for adjusting the position of the cartridge with respect to the body of the handpiece. One form of the adjustment means is a dual wedge arrangement comprising oppositely inclined ramps in abutting relationship such that the precise position of the cartridge can be adjusted by the two inclined ramps sliding with respect to each other. This form of the adjustment means permits adjustment in a circumferential direction.

Typically, the fingers of the comb may take any form such as being rounded, or have any profile or be of any length. Further, the fingers may be identical to each other or different in shape, profile, size, length or the like, or combinations thereof. Typically, the ends of the fingers may form a straight contour or a curved contour such as a simple or compound curve.

Typically, the distal end of the projections of the cartridge are provided with tips, tabs or similar enlargements having an internal groove for receiving the distal end of the chips. When the distal end of the chip is located in the groove, the tab or similar helps to protect the end of the chip from damage and assist in accurately locating the chip in the recess so that it moves axially in the recess in use. Furthermore, the presence of the tip and groove arrangement contributes to preventing stray fibres of material, particularly wool, from inadvertently becoming lodged between the chip and recess of the cartridge which is undesirable as the movement of the chip would be impaired and the cutting action reduced. In extreme cases, clumps of fibres could accumulate, thereby dislodging the chip from the recess. The presence of tips, tabs, flanges, grooves, or lips at the end of the projections prevents this.

Typically, the body or comb of the handpiece of the present invention is provided with one or more grooves, undercuts or cut-outs at or towards the proximal end of the fingers. The cut-outs are positioned at or towards the root of the fingers for receiving the tips or tabs of the cartridge projections in order to assist in positively locating the cartridge with respect to the comb in the handpiece and to protect the tips or tabs of the cartridge protections. In one embodiment, the cut-outs are located a small distance away from the root of the fingers so as to define a gap between the upper surface of the fingers of the comb and the lower surface of the fingers on the other side of the undercut. The length of the lower surface of the fingers is less than the length of the upper surface of the fingers. The distal end of the projections of the cartridge and the distal ends of the chips are located in the undercut and gap in the assembled handpiece. This arrangement of the projections and chips being received in the undercuts and gaps also provides a combination which inhibits or prevents stray woollen fibres from being wound around the rotating blade and hub in use, as it prevents the fibres from lodging under the chips or around the projections of the cartridge.

The rotary handpiece of the present invention may be operated by any suitable means or method known in the art. One typical method of operation is described in Australian provisional patent specification No. PN0833. Typically, a drive shaft is rotated by suitable driving means which in turn rotates pinion and meshed gear thus turning an axle hub which causes the cutting means to rotate.

The present invention will now be described by way of example with reference to the accompanying drawings in which:

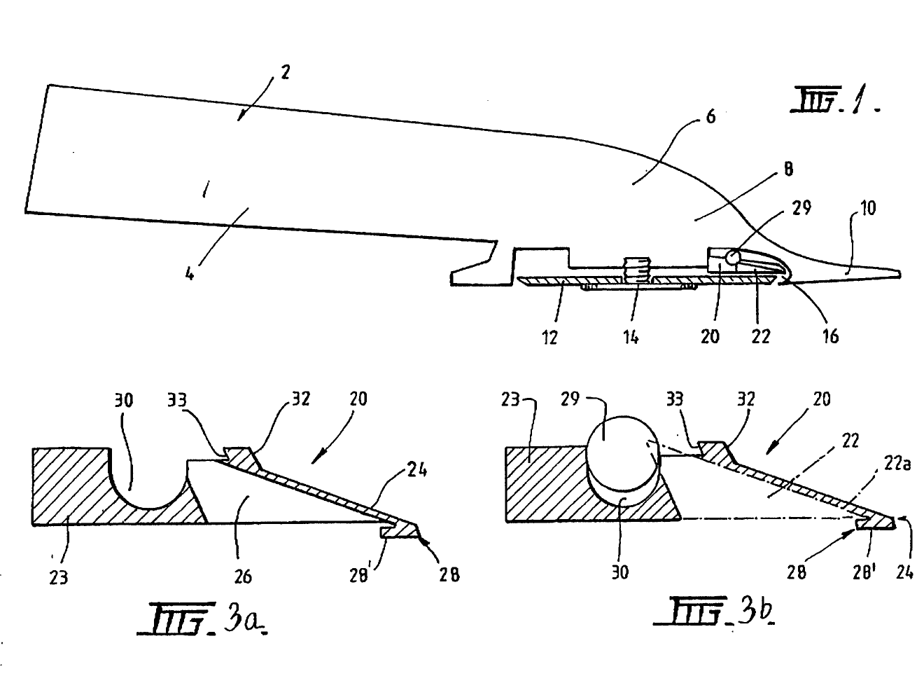

FIG. 1 is cross-sectional view of one form of the rotary handpiece of the present invention;

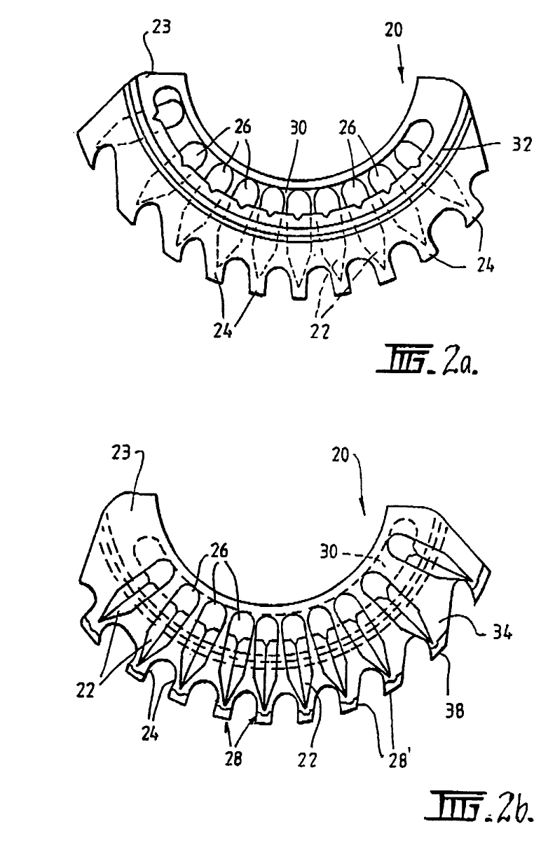

FIG. 2a is a top view of one form of the cartridge of the present invention;

FIG. 2b is an underneath view of the cartridge of FIG. 2a;

FIG. 3a is a cross-sectional view through the cartridge of FIGS. 2a and 2b from which the cutting chip and biasing means have been removed;

FIG. 3b is a view similar to FIG. 3a showing one form of the cutting chip and the biasing means in place;

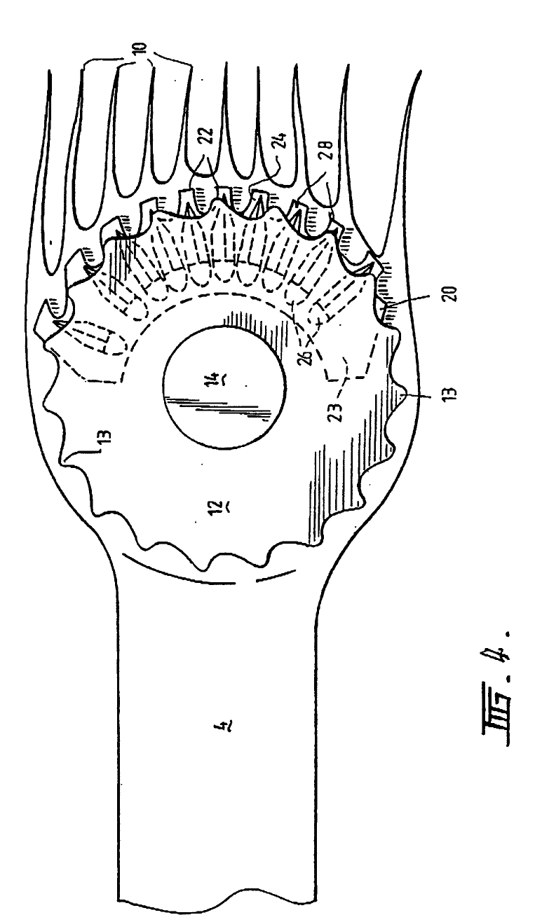

FIG. 4 is an underneath view of the front portion of the rotary handpiece of FIG. 1 having the replaceable cartridge of the present invention having the cutting chips located in recesses in place within the handpiece of the present invention;

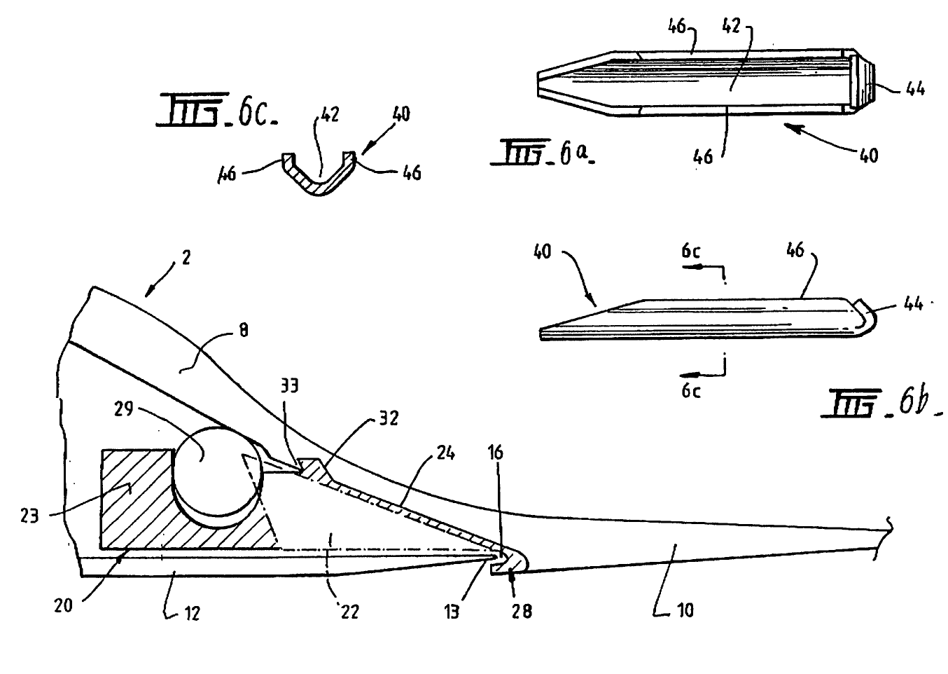

FIG. 5 is a cross-sectional view of the front portion of the rotary handpiece of FIG. 1 showing the relationship between the rotary blade, the replaceable cartridge and cutting chips located in situ within a handpiece;

FIGS. 6a, 6b and 6c are top plan, side elevation and sectional views, respectively, of one form of the cutting chip being a hollow V-shape chip provided with a protective rear tab.

FIG. 1 shows a rotary handpiece, generally denoted as 2. The rotary handpiece 2 comprises a rear portion which acts as a handle 4 for holding the handpiece. The rearmost part of the handle 4 is optionally fitted with an adaptor to allow it to be used in an automatic shearing apparatus. Alternately, the rear of the handpiece is provided with a coupling for connecting the headpiece to a suitable driving means, such as a rotating shaft. Alternatively, the headpiece may be connected to or provided with its own motive power, such as for example an electric motor or compressed air motor or similar. The forward portion of the rotary handpiece comprises hub 6 and a body 8, in which the body 8 comprises an integral guide means in the form of a comb having multiple fingers 10 arranged in parallel relationship to each other and extending in the normal in use forward direction. The cutting assembly of the handpiece is located in the underside of the body beneath the region of the forward part of body 8 and hub 6.

It is to be noted that the use of terms describing the orientation of the rotary handpiece such as rear, forward, underside and the like refer to the rotary handpiece when in its normal in use position as shown in FIG. 1. The use of such expressions is for ease of understanding and clarity of expression and is not meant to be limiting.

The hub 6 and rear portion 8 of the rotary handpiece enclose the drive mechanism (not shown) which rotates the cutting arrangement. Typically, the drive mechanism is of the type described in respect of FIG. 1 of Australian patent application No. PN0833. Cutting member 12 is in the form of a substantially planar disc-like blade and is connected to a hub axle (not shown) by blade retainer plate 14 . Blade retainer plate 14 is provided with a centrally located externally threaded boss which is threadingly received into a correspondingly threaded internal bore located at the end of the internal bore of the hub axle. The blade retainer plate 14 is tightened to the hub axle to retain the blade 12 in place and to allow blade 12 to rotate in use when driven.

At the rear of each finger 10 there is an undercut or groove 16 in which distal ends of projections of the replaceable cartridge 20 may be located. The replaceable cartridge 20 is located between body 8 and blade 12 as shown in FIG. 1.

Cartridge 20 comprises a substantially arcuate body portion 23 from which extends in an outwardly directed radial direction in more or less regularly spaced apart relationship a plurality of projections 24. The angle of extension of the radial projections can be the same or may differ between individual projections depending on the position of the individual projection in the array of projections. Recesses 26 are aligned or associated with the projections 24 and are typically but not necessarily located to one side of the respective projections 24. The projections are each provided with a lip, flange, groove, tip or tab, collectively denoted as 28, at each distal end for retaining chips 22 in recesses 26 in use.

The cartridge 20 comprises a plurality of cutting elements in the form of multi-faceted or V-section chips 22, with each chip 22 being located in a respective recess 26 which in turn are located rearwardly and generally aligned along projections 24 of the cartridge 20. However, recesses 26 and projections 24 may adopt a number of spatial relationships with respect to each other. The chips 22 are located such that one cutting face or edge of the chip is adjacent the cutting surface of the teeth of rotating blade 12 as it rotates. The cartridge 20 is held in place by a flange on the body (not shown) and biased against the body by flexible polymeric tubing 29 extending arcuately around the body 23 of the handpiece in correspondence to the substantially semi-circular body of the cartridge. In addition, polymeric tubing 29 provides a biasing force for chips 22 to firstly maintain the chips in recesses 26 and secondly to maintain contact between the cutting surfaces of the chips 22 and the teeth of rotary blade 12.

FIGS. 2a and 2b illustrate one form of the cartridge of the present invention which is suitable for use in the rotary handpiece of FIG. 1. FIG. 2a shows the obverse side of the cartridge 20 whilst FIG. 2b shows the reverse side of the cartridge 20. The cartridge comprises a generally arcuate body portion 23 of generally semi-circular shape subtending an arc of less than about 180° but greater than about 90°, typically about 110° to 160°, preferably about 120° to 150°. The body portion is provided with an elongate, arcuate depression 30 which generally corresponds to the curve of the body portion. A biasing means such as length of a rubber or polymeric tubing or similar 29 is inserted in depression 30 and is held in place by interference fit. It is to be noted that tubing 29 has been omitted from FIGS. 2a and 2b for the sake of clarity. The body portion 23 is provided with a locating lip which is of substantially trapezoidal cross-section having at least one tapered or sloping side surface which is designed to receive an appropriately shaped flange provided on the body of the rotary handpiece, typically the undercut at or towards the proximal end of fingers 10. The body portion 23 of the cartridge 20 further comprises a plurality of generally arcuate projections 24 extending radially outward from the longer side of body 23.

FIG. 2b shows the body portion 20 of the cartridge including the projections. The body portion comprises a plurality of recesses 26 having a generally V-shaped cross-section. The longitudinal axis of each recess is in a direction extending radially outward. Each recess 26 is associated with and extends at least partly along a projection 24 and accordingly is aligned with projections 24. In use each recess is provided with a cutting chip 22 of a generally multi-faceted triangular prism shape or of a V-grooved shape in which two adjacent faces of the cutting chip are received into the V-shaped profile of the recess 36. In one embodiment only one or at least a part of one of the cutting surface of the cutting chip is exposed when the cutting chip is located in the recess. In other embodiments, different amounts of the cutting surfaces are exposed. When the cutting chip is located in the recess, the foremost apex of the triangular prism is located at or near the distal end of the projection. The distal end of the projection may he curved out of the plane of the chip so that the distal end of the cutting chip in whatever form it takes is partly enclosed or held within the curved edge of the projection. This helps to stop the cutting chip from being displaced from the elongate recess 26. The rearmost apex of the cutting chip projects into the depression 30 and contacts the biasing means 29 located therein. The biasing means 29 acts to hold the cutting chip in place in the recess 26 as well as biasing the movement of the chip.

FIG. 3a shows a cross-sectional view through the body portion of cartridge 20 and along an elongate recess 26 and projection 24 of the cartridge of FIG. 2a. The recess 26 has a generally V-shaped cross-section and extends partly along the projection 24. The distal end 28 of projection 24 is carved and points rearwardly under the body portion to form a tip or tab 28. The body portion 23 of cartridge 20 is provided with a locating lip 32 which is of substantially trapezoidal cross-section having at least one tapered or sloping side surface 33 which is designed to receive an appropriately shaped flange provided on the upper surface of the recess (not shown) to retain cartridge 20 in place within the handpiece. The body portion is provided with an arcuate depression 30 into which a biasing means such as polymeric tubing 29 (not shown in this figure) may be inserted to provide biasing of chips 22 in recesses 26.

FIG. 3b shows a body portion 23 of the cartridge 20 having recess 26 into which has been fitted a cutting chip 22 and a piece of polymeric tubing 29 to act as the biasing means. The distal end 22a of the chip 22 is located near the end 28 of the projection 24, which end is curved out of the plane of the cartridge to retain the chip 22. The distal end of the cutting chip 22 is partly enclosed or held within the curved edge 28 of the projection 24 . This helps to stop the cutting chip being displaced from the recess. The rearmost apex of the cutting chip projects into the depression 30 and contacts the biasing means 29. Where the cutting chip is made of metal and the biasing means comprises a comparatively soft, flexible or resilient polymeric material, the apex of the cutting chip tends to bite into or impinge upon the biasing means; the resilience of the biasing means acts to push or hold the cutting chip firmly against the V-shaped walls of the recess. Thus the curved edge of the projection and the biasing means both acts to hold the cutting chip 22 in place in the recess 26. The V-shape of the recess also helps to rigidly locate the cutting chip in the recess and prevent lateral movement, even when there is wear or variations in manufacturing tolerances, particularly so when the chip 22 is of a shape corresponding to the shape of the recess being in the hollow V-shape having a central longitudinal groove. If an operator should wish to remove or replace cutting chips from the cartridge, minimal manual force against the biasing force is required to dislodge the cutting chips from the cartridge when the cartridge has been removed from the handpiece.

FIG. 4 shows the underside of the handpiece of FIG. 1. The drawing shows part of the handle 4 and the generally circular body 8, which comprises integral guide means consisting of fingers 10 in substantially parallel arrangement for guiding the handpiece across for example, a fleece. Attached to the body 8 is the cartridge 20 in which is located a plurality of cutting elements 22. A cutting member in the form of a substantially planar blade 12 having a plurality of cutting teeth 13 circumferentially located at regular intervals around the edge of blade 12 is connected to a hub axle (not shown) by blade retainer plate 14. The blade retainer plate is tightened to the hub axle thus retaining the blade in place whilst allowing it to rotate.

Each chip 22 of the cartridge 20 is located adjacent a projection 24 on the body portion 23 of the cartridge 20; each projection in turn is located adjacent a finger 10 of the body 8 of the rotary handpiece 2. The cutting elements 22 are located such that one cutting face or edge of the cutting chip 22 is located adjacent the cutting surface of the teeth 13 of rotary blade 12 as it rotates. Chips 22 move axially backwards and forwards in use in each respective recess 26 in response to being contacted by teeth 13. It is the rotary action of the rotary blade in co-operation with the axial movement of chip 22 that produces a sliding or slicing action between the chip 22 and tooth 13 which cuts material located between the two.

FIG. 5 depicts the relationship between the various operative cutting components of the cutting assembly of the handpiece being the rotary cutting blade 12 and cutting chip 22 of cartridge 20 in place in the forward portion of the headpiece. The drawing shows part of the body 8 and an integral finger 10. Attached to body 8 of the handpiece is the substantially planar blade 12 and cartridge 20 in which is located chip 22. The cartridge is held in place in the body by a flange which contacts a correspondingly shaped recess formed by a lip 16 on the chip. As the blade rotates in use, the teeth 13 or cutting surfaces of the blade 12 come into contact with the cutting surfaces of cutting chips 22. The biasing means 29 acts to impart a forward bias on the chip 22, urging the cutting surface of the chip onto the cutting surface of the blade. Any material located between the chip and the cutting surface of the blade is severed at the point of contact between the two.

FIG. 6a shows a top plan view, FIG. 6b a side elevation view and FIG. 6c a sectional view through line 6 to 6 of FIG. 6b of one form of the cutting chip used in the replaceable cartridge of the present invention. This form of the chip 40 is a hollow V-shape chip having a centrally located lengthwise extending groove 42 and is provided with a rear tab or extension 44 which is folded upon and around the ends of the sides 46 of the chip 40 to form a bearing pad or similar, as is particularly shown in FIG. 6b. The bearing pad is in contact with the resilient biasing means 29 and prevents the end of the chip 40 from puncturing, cutting or otherwise damaging the resilient biasing means 29. In the embodiment illustrated in FIG. 6, the tab 44 is folded back upon itself through an angle of greater than about 90°, typically from about 110° to 160°, so that the distal end of tab 44 contacts the top of the rear side edges 46 in use to form a round end to chip 40.

One modification of the cartridge of the present invention relates to the cutting chip. In this modification which particularly relates to the V-shape form of the chips having the central groove, the rear of the chip is provided with a tab or similar in the form of a reinforcement at the inboard end of the chip where it bears against the biasing means. In this embodiment, the chip is made with a small tab or extension piece at the rearward end so that the extension can be folded upon itself over the end to provide reinforcement of the end and a bearing surface in order to protect the biasing means from being damaged by the chip in use. The provision of the extension allows the end to be rounded or to provide a smoother surface for contact by the biasing means thereby prolonging the life of the biasing means.

The described arrangement has been advanced by explanation and many modifications may be made without departing from the spirit and scope of the invention which includes every novel feature and novel combination of features herein disclosed. Those skilled in the art will appreciate that the invention described herein is susceptible to variations and modifications other than those specifically described. It is understood that the invention includes all such variations and modifications which fall within the spirit and scope.

1. A replaceable cartridge suitable for use in a rotary handpiece having a rotary cutting member, characterised in that the replaceable cartridge comprises a body portion having at least one recess, said recess being adapted for releasably receiving a cutting element, wherein when said replaceable cartridge is located in situ in the handpiece the rotary cutting member co-operatively interacts with the cutting element to cut material located between the cutting member and cutting element.

2. A cartridge according to claim 1, characterised in that the cartridge is stationary when located in the handpiece.

3. A cartridge according to claim 1 or 2, characterised in that the cartridge has a plurality of recesses for receiving respective ones of a plurality of cutting elements.

4. A cartridge according to any preceding claim, characterised in that the cartridge comprises a generally arcuate body portion having a plurality of projections extending substantially radially outwards from the body portion.

5. A cartridge according to claim 4, characterised in that the plurality of projections are substantially regularly spaced apart and in that the projections are individually shaped and extend from the body portion at individual angles whilst being generally radially directed.

6. A cartridge according to any preceding claim, characterized in that the cartridge further includes a biasing means for providing a bias to the cutting elements radially outwardly in their lengthwise extending direction.

7. A cartridge according to claim 6, characterized in that the biasing means is made of a plastics or synthetic or natural rubber material and is in the form of a length of tubing of the rubber or plastics material.

8. A cartridge according to claim 6 or 7, characterised in that the cartridge is provided with an arcuate groove, channel or depression for receiving the biasing means.

9. A cartridge according to any one of claims 6 to 8, characterised in that the biasing means provides bias to the cutting elements to assist in maintaining the cutting element in the recess and for maintaining the cutting element in contact with the rotary cutting member.

10. A cartridge according to any preceding claim, characterized in that when the cutting element is located in the recess the cutting element extends in the direction of the projection and is provided with a cutting surface which is at least partially exposed in order to contact the teeth of the rotary blade.

11. A cartridge according to claim 10, characterised in that the cutting surface or edge of the cutting element is exposed at or towards one side of the projection with which the recess and cutting chip are associated.

12. A cartridge according to any preceding claim, characterised in that each finger of the guiding means of the handpiece is provided with a locating means for locating the distal end of the projections of the cartridge in use.

13. A cartridge according to claim 12, characterised in that the locating means of the fingers is a lip, flange, grove or similar.

14. A cartridge according to any preceding claim, characterised in that the cartridge is provided with a means for maintaining the cutting elements in position in the respective recesses.

15. A cartridge according to claim 14, characterised in that the maintaining means is a lip, flange, groove or similar.

16. A cartridge according to any preceding claim, characterised in that the cutting elements are in the form of a triangular prism or a grooved V-shape.

17. A cartridge according to any preceding claim, characterised in that the cutting chip is provided with a tab or extension at or towards one end, said end being for contact with the biasing means.

18. A cartridge according to any preceding claim, characterised in that the cartridge is provided with an adjustment means for adjusting the position of the cartridge within the handpiece.

19. A rotary handpiece suitable for cutting or severing a material, comprising a cutting member capable of rotary motion in a first direction, at least one cutting element capable of substantially linear movement in a second direction, said motion in the first direction being different to that in the second direction, and a replaceable cartridge provided with at least one recess, characterised in that the replaceable cartridge comprises at least one cutting element locatable in the at least one recess, and in that the cutting member and cutting element are arranged with respect to each other so as to cooperatively interact in use to cut or sever material located therebetween.

20. A rotary handpiece according to claim 19, characterised in that the cartridge is in accordance with any one of claims 1 to 18.

21. A replaceable cartridge in combination with a comb suitable for use with a handpiece, wherein said cartridge is characterised in that it includes a body portion having a plurality of recesses oriented to extend in a radially outwards direction from the body portion, said recesses being adapted to receive replaceable cutting elements, said body further including outwardly radially extending projections associated with the recesses, said projections being provided with retaining means for retaining the cutting elements in the recesses, wherein said cutting elements are free to move axially within the recesses in use.

22. A replaceable cartridge according to claim 21, characterised in that the replacement cartridge is in accordance with any one of claims 1 to 18.

23. A replaceable cartridge substantially as hereinbefore described with reference to the accompanying drawings.
